(19) United States
(12) Patent Application Publication
(10) Pub. No.: US 2011/0262839 A1
(43) Pub. Date: Oct. 27, 2011

(54) PROTON CONDUCTING ELECTROLYTE MEMBRANES HAVING NANO-GRAIN YSZ AS PROTECTIVE LAYERS, AND MEMBRANE ELECTRODE ASSEMBLIES AND CERAMIC FUEL CELLS COMPRISING SAME

(75) Inventors: Sang-kyun Kang, Seoul (KR); Joong-Sun Park, Stanford, CA (US); Turgut M. Gür, Palo Alto, CA (US); Young-beom Kim, Stanford, CA (US); Friedrich B. Prinz, Woodside, CA (US); Joon-hyung Shim, Seoul (KR)

(73) Assignees: The Board of Trustees of The Leland Stanford JR. University, Palo Alto, CA (US); Samsung Electronics Co., Ltd., Suwon-si (KR)

(21) Appl. No.: 13/092,563

(22) Filed: Apr. 22, 2011

(30) Foreign Application Priority Data
Apr. 23, 2010 (KR) 10-2010-0038181
Aug. 18, 2010 (KR) 10-2010-0080000
Feb. 16, 2011 (KR) 10-2011-0013682

(51) Int. Cl. H01M 8/12; H01M 8/10; B82Y 99/00

(52) U.S. Cl. 429/496; 429/479; 429/495; 977/700

(57) ABSTRACT

A proton conducting electrolyte membrane comprising a ceramic electrolyte layer including an inorganic proton conductor and a ceramic protective layer formed on at least one surface of the ceramic electrolyte layer and having proton conductivity; a membrane electrode assembly including the proton conducting electrolyte membrane; and a proton conducting ceramic fuel cell including the membrane electrode assembly. In the proton conducting electrolyte membrane, the ceramic protective layer may have an improved chemical bond with the ceramic electrolyte layer compared with a Pd metal protective layer, such that interlayer delamination may be lessened. Also, compared with a Pd metal protective layer, the ceramic protective layer is more appropriate for ceramic electrolytes such as BYZ and BYC that transmit protons or simultaneously transmit protons and oxygen ions used in a fuel cell operating at a temperature range of about 200 to about 500° C., for example, about 250 to about 500° C.

### CROSS-REFERENCE TO RELATED APPLICATIONS

This application claims the benefit of Korean Patent Application Nos. 10-2010-0038181, filed on Apr. 23, 2010, 10-2010-0080000, filed on Aug. 18, 2010, and 10-2011-0013682, filed on Feb. 16, 2011, all in the Korean Intellectual Property Office, the disclosures of which are incorporated herein in their entireties by reference.

### BACKGROUND

1. Field

Aspects of the present disclosure relate to proton conducting electrolyte membranes, and membrane electrode assemblies and fuel cells including the same, and more particularly, to proton conducting electrolyte membranes having nano-grain yttrium-stabilized zirconia (YSZ) as ceramic protective layers thereof, as well as membrane electrode assemblies and ceramic fuel cells including the same.

2. Description of the Related Art

In a fuel cell, an electrolyte is interposed between two electrodes, each formed of an electrochemical catalyst including a porous metal or carbon. It is called a single cell. Hydrogen gas or other fuel is supplied to an anode from the outside, reaches near a reaction region through pores in the electrode, and is adsorbed on a catalyst in the electrode so as to be dissociated hydrogen atoms. Such a hydrogen atom becomes two hydrogen ions, i.e. protons, and two electrons move to a cathode through an external circuit. Accordingly, a current flows. In the cathode, oxygen supplied from the outside, hydrogen ions reached through the electrolyte, and the electrons reached through the external circuit react together, thereby generating water.

In a high temperature fuel cell using a ceramic electrolyte such as a solid oxide fuel cell (SOFC), the operating temperature is sufficiently high, about 800-1000° C., and thus low-cost metals such as nickel and oxides such as lanthanum strontium manganite may be used as catalysts. However, in such high temperature fuel cells, the difference between operating temperature and starting temperature is very high and thus the initialization of high temperature fuel cells is slow. Also, stress due to the difference in thermal deformation of each material is accumulated while turning on and off a high temperature fuel cell so that durability of the fuel cell decreases. In addition, high-cost conductive materials (for example, an INCONEL® alloy, Special Metals Corp.), which resist oxidation/reduction reactions at high temperature, should be used as inter-connectors. In addition, since a glass-based material should be used as a sealing material, it is difficult to manufacture a high temperature fuel cell and the high temperature fuel cell has weak resistance to shocks.

When the operating temperature of a high temperature fuel cell is below 600° C., stainless steel may be used as an inter-connector. In addition, sealing may be more easily performed at a temperature of around 200° C. However, even if the thickness of an oxygen ion conductor used in a high temperature fuel cell is reduced, resistance to ionic conduction is very high at a temperature of 300° C. or less and, thus, it is difficult to use the oxygen ion conductor.

Use of a proton (hydrogen ion) conducting ceramic having a cation-doped perovskite structure as an electrolyte of a fuel cell operating at about 200 to 500° C., for example, 250 to 500° C., has been considered. For example, ceramic proton conductors such as yttrium-doped barium zirconate (BYZ:Ba₁₋ₓYₓZrO_{3-δ} or Y:BaZrO₃) and yttrium-doped barium cerate (BYC:Ba₁₋ₓYₓCeO_{3-δ} or Y:BaCeO₃) may have sufficient ionic conductivity at a temperature of 300° C. or less. However, since carbonation may occur after barium zirconate or barium cerate reacts with CO₂ (BaZrO₃+CO₂→BaCO₃+ZrO₂; BaCeO₃+CO₂→BaCO₃+CeO₂) and sintering of BYZ or BYC is difficult, forming a fuel cell using such a ceramic proton conductor is unsatisfactory. However, according to recent development of a thin film process, a proton conducting ceramic film having a cation doped perovskite structure such as BYZ or BYC may be created without a sintering process through atomic layer deposition (ALD). In addition, since ionic conductivity of BYZ and BYC is high even at a low temperature, a fuel cell may be constructed at a temperature of around 80° C. by using BYZ or BYC which has been formed as a thin film having a thickness of 100 nm. In this case, however, carbonation needs to be prevented. More specifically, CO₂ generally included in fuel flows into a fuel cell through an anode and carbonates the BYZ or BYC used as an electrolyte. When methanol is used as a fuel, methanol is oxidized at an anode and thus CO₂ is generated so that carbonation may occur as in a cathode. Moreover, it is known that ceramic proton conductors such as BYZ and BYC react with CO₂ in the atmosphere (concentration: 330-380 ppm) at a temperature of 300° C. or less and thus carbonation occurs. Accordingly, in addition to an anode, a cathode may also need to be separated from CO₂ in order to protect ceramic proton conductors such as BYZ and BYC.

### SUMMARY

Aspects of the present invention provide proton conducting electrolyte membranes, each proton conducting electrolyte membrane including a ceramic protective layer having high compatibility with a ceramic electrolyte layer that includes an inorganic proton conductor having reactivity with carbon dioxide.

Aspects of the present invention provide membrane electrode assemblies each including the proton conducting electrolyte membrane.

Aspects of the present invention provide proton conducting ceramic fuel cells each including the proton conducting electrolyte membrane.

According to an aspect of the present invention, a proton conducting electrolyte membrane includes: a ceramic electrolyte layer comprising an inorganic proton conductor; and a ceramic protective layer formed on one surface or both surfaces of the ceramic electrolyte layer and having proton conductivity.

The ceramic protective layer may include polycrystalline yttrium-stabilized zirconia (YSZ) in an amorphous YSZ matrix in which the crystal grain of the polycrystalline YSZ comprises a nano-grain YSZ having an average crystal grain size of about 100 nm or below; M¹ₓM²₁₋ₓP₂O₇ (0<x<0.5) in which M¹ is a tetravalent metal cation, and M² is a monovalent to trivalent metal cation; MₓLa₁₋ₓPO₄ (0<x<0.5) in which Mₓ is Sr or Ca; CsH₂PO₄, or NH₄PO₃; at least one cathodic material selected from lanthanum strontium cobalt ferrite (LSCF), lanthanum strontium manganite (LSM), lanthanum strontium ferrite (LSF), lanthanum calcium manganite (LCM), lanthanum strontium chromite (LSC), lanthanum strontium gallate manganite (LSGM), barium strontium calcium ferrite (BSCF), and strontium-doped samarium cobaltite (SSC); Ba₂In₂O₇ doped with at least one cation; at least one doped perovskite selected from a parent perovskite group consisting of BT (barium titanate) doped with at least one of a divalent cation and a trivalent cation, ST (strontium titanate) doped with at least one of a divalent cation and a trivalent cation, and SZ (strontium zirconate) doped with at least one of a divalent cation and a trivalent cation; an amorphous ZrP₂O₇; or an amorphous Al:SiO₂.

The average crystal grain size of the nano-grain YSZ may be greater than or equal to about 5 nm and less than about 100 nm.

The nano-grain YSZ may have proton conductivity at a temperature of about 200 to about 500° C.

A deuterium (²H) concentration of the nano-grain YSZ measured after the nano-grain YSZ is exposed for two hours at 450° C. under a D₂O(²H₂O) atmosphere of 15 mTorr may be greater or equal to 0.05×10¹⁹/cm³.

The inorganic proton conductor may include at least one doped perovskite selected from a parent perovskite group including barium zirconate (BZ) doped with at least one of a divalent cation and a trivalent cation, barium cerate (BC) doped with at least one of a divalent cation and a trivalent cation, strontium cerate (SC) doped with at least one of a divalent cation and a trivalent cation, strontium zirconate (SZ) doped with at least one of a divalent cation and a trivalent cation, and solid solutions thereof.

The nano-grain YSZ may be formed by using atomic layer deposition (ALD), chemical vapor deposition (CVD), pulsed laser deposition (PLD), sputtering, or spray pyrolysis.

The ceramic protective layer may prevent penetration of carbon dioxide.

The ceramic electrolyte layer may have a thickness of less than or equal to about 2 μm.

The ceramic protective layer may have a thickness of less than or equal to about 100 nm.

According to another aspect of the present invention, a membrane electrode assembly includes: an anode; a cathode; and a ceramic electrolyte membrane disposed between the anode and the cathode, wherein the ceramic electrolyte membrane is a proton conducting electrolyte membrane comprising an inorganic proton conductor and a ceramic protective layer formed on one surface or both surfaces of the electrolyte layer and having proton conductivity.

The anode and the cathode may each independently include at least one selected from the group consisting of: platinum (Pt); nickel (Ni); palladium (Pd); silver (Ag); perovskite doped with at least one metal selected from the group consisting of lanthanum (La), strontium (Sr), barium (Ba), and cobalt (Co); yttrium (Y) or scandium (Sc)-doped zirconia; ceria (Ce) doped with at least one rare earth selected from the group consisting of gadolinium (Gd), samarium (Sm), lanthanum (La), ytterbium (Yb), and neodymium (Nd); at least one proton conducting metal selected from the group consisting of Pd, a Pd—Ag alloy, RuO₂, H×WO₃ (0<x≦1), and V; zeolite; a lanthanum (La) or calcium (Ca)-doped strontium manganese oxide (LSM); and a lanthanum strontium cobalt iron oxide (LSCF).

At least one of the anode and the cathode may further include a catalyst.

The catalyst may include one or more metals or alloys selected from the group consisting of platinum (Pt), gold (Au), silver (Ag), ruthenium (Ru), nickel (Ni), palladium (Pd), cobalt (Co), titanium (Ti), and vanadium (V).

The catalyst may include at least one oxide catalyst selected from the group consisting of La₁₋ₓSrₓMnO₃ (0<x<1), La₁₋ₓSrₓCoO₃ (0<x<1), and La₁₋ₓSrₓCO_{y}Fe_{1-y}O₃ (0<x<1, 0<y<1).

The catalyst may include at least one metal or alloy selected from the group consisting of Pt, Pt—Ru, Pt—Co, Pt—Fe, Pt—Ni, Pt—Ti, and Pt—V.

According to another aspect of the present invention, a proton conducting ceramic fuel cell includes a membrane electrode assembly according to an aspect of the present invention.

The proton conducting ceramic fuel cell may include at least one fuel selected from the group consisting of hydrogen, methane, natural gas, methanol, ethanol, dimethyl ether, and liquefied hydrocarbon gas.

According to another aspect of the present invention, a method of forming a membrane electrode assembly including a proton conducting ceramic electrolyte membrane includes: forming an anode; forming a cathode; forming a ceramic electrolyte layer interposed between the anode and the cathode, wherein the ceramic electrolyte layer includes an inorganic proton conductor capable of reacting with carbon dioxide; and forming a ceramic protective layer having proton conductivity on one surface or both surfaces of the ceramic electrolyte layer, wherein the forming of the ceramic electrolyte layer including the inorganic proton conductor and the forming of the ceramic protective layer are performed in the same reaction chamber.

The step of forming the anode, the step of forming the cathode, the step of forming the ceramic electrolyte layer, and the step of forming the ceramic protective layer may be performed in any order.

According to another aspect of the present invention, a method of forming a membrane electrode assembly including a proton conducting electrolyte membrane includes: forming a ceramic electrolyte layer including an inorganic proton conductor capable of reacting with carbon dioxide on a front side of a substrate; removing a predetermined area of the back side of the substrate to expose the back side of the ceramic electrolyte layer; forming a ceramic protective layer having proton conductivity on at least one of the back side of the exposed ceramic electrolyte layer and the front side of the ceramic electrolyte layer opposite to the back side of the exposed ceramic electrolyte layer; and forming an anode and a cathode on the ceramic protective layer.

The ceramic protective layer may include polycrystalline yttrium-stabilized zirconia (YSZ) in an amorphous YSZ matrix in which the crystal grain of the polycrystalline YSZ comprises a nano-grain YSZ having an average crystal grain size of about 100 nm or below; M¹ₓM²₁₋ₓP₂O₇ (0<x<0.5) in which M¹ is a tetravalent metal cation, and M² is a monovalent to trivalent metal cation; MₓLa₁₋ₓPO₄ (0<x<0.5) in which Mₓ is Sr or Ca; CsH₂PO₄, or NH₄PO₃; at least one cathodic material selected from lanthanum strontium cobalt ferrite (LSCF), lanthanum strontium manganite (LSM), lanthanum strontium ferrite (LSF), lanthanum calcium manganite (LCM), lanthanum strontium chromite (LSC), lanthanum strontium gallate manganite (LSGM), barium strontium calcium ferrite (BSCF), and strontium-doped samarium cobaltite (SSC); Ba₂In₂O₇ doped with at least one cation; at least one doped perovskite selected from a parent perovskite group consisting of BT (barium titanate) doped with at least one of a divalent cation and a trivalent cation, ST (strontium titanate) doped with at least one of a divalent cation and a trivalent cation, and SZ (strontium zirconate) doped with at least one of a divalent cation and a trivalent cation; an amorphous ZrP₂O₇; or an amorphous Al:SiO₂.

According to another aspect of the present invention, a method of forming a membrane electrode assembly including a proton conducting electrolyte membrane includes: forming a ceramic electrolyte layer on a front side of a substrate, wherein the ceramic electrolyte layer includes an inorganic proton conductor capable of reacting with carbon dioxide; removing a predetermined area of the back side of the substrate to expose the back side of the ceramic electrolyte layer; forming a ceramic protective layer having proton conductivity on at least one of the back side of the exposed ceramic electrolyte layer and the front side of the ceramic electrolyte layer opposite to the back side of the exposed ceramic electrolyte layer; and forming an anode and a cathode on the ceramic protective layer, wherein the ceramic protective layer may include polycrystalline yttrium-stabilized zirconia (YSZ) in an amorphous YSZ matrix in which the crystal grain of the polycrystalline YSZ comprises a nano-grain YSZ having an average crystal grain size of about 100 nm or below; M¹ₓM²₁₋ₓP₂O₇ (0<x<0.5) in which M¹ is a tetravalent metal cation, and M² is a monovalent to trivalent metal cation; MₓLa₁₋ₓPO₄ (0<x<0.5) in which Mₓ is Sr or Ca; CsH₂PO₄, or NH₄PO₃; at least one cathodic material selected from lanthanum strontium cobalt ferrite (LSCF), lanthanum strontium manganite (LSM), lanthanum strontium ferrite (LSF), lanthanum calcium manganite (LCM), lanthanum strontium chromite (LSC), lanthanum strontium gallate manganite (LSGM), barium strontium calcium ferrite (BSCF), and strontium-doped samarium cobaltite (SSC); Ba₂In₂O₇ doped with at least one cation; at least one doped perovskite selected from a parent perovskite group consisting of BT (barium titanate) doped with at least one of a divalent cation and a trivalent cation, ST (strontium titanate) doped with at least one of a divalent cation and a trivalent cation, and SZ (strontium zirconate) doped with at least one of a divalent cation and a trivalent cation; an amorphous ZrP₂O₇; or an amorphous Al:SiO₂.

Forming of an etch-stop layer on the front side of the substrate may be further included before the forming of the ceramic electrolyte layer on the front side of the substrate. In this case, when a predetermined area of the back side of the substrate is removed, the substrate may be removed by using wet etching and then the etch-stop layer may be removed by dry etching, thereby exposing the back side of the ceramic electrolyte layer.

The substrate may be a silicon substrate and the etch-stop layer may be a silicon nitride layer, a silicon oxide layer, or a metal or alloy layer including Cr, Au, Pd, Pd—Ag, V, or Pt.

Forming of a catalyst on at least any one of the anode and the cathode may be further included in the method of forming a membrane electrode assembly including a proton conducting electrolyte membrane.

Additional aspects will be set forth in part in the description which follows and, in part, will be apparent from the description, or may be learned by practice of the invention.

### BRIEF DESCRIPTION OF THE DRAWINGS

These and/or other aspects of the invention will become apparent and more readily appreciated from the following description of the embodiments, taken in conjunction with the accompanying drawings, of which:

FIG. 1 is a cross-sectional view of a membrane electrode assembly including a proton conducting electrolyte membrane, according to an embodiment of the present invention;

FIGS. 2A through 2F are cross-sectional views illustrating a method of manufacturing a membrane electrode assembly including a proton conducting electrolyte membrane, according to another embodiment of the present invention;

FIG. 3 is a graph showing the changes in deuterium concentration according to thicknesses of YSZ layers in Preparation Example 1 (nano-YSZ (ALD)), Preparation Example 2 (nano-YSZ (PLD)), and Preparation Example 3 (micro-YSZ) measured by using secondary ion mass spectroscopy (SIMS); and

FIG. 4 is a graph showing cell performance evaluation for a membrane electrode assembly manufactured according to Example 3.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures. Moreover, it is to be understood that where is stated herein that one layer is “formed on” or “disposed on” a second layer, the first layer may be formed or disposed directly on the second layer or there may be an intervening layer between the first layer and the second layer. Further, as used herein, the term “formed on” is used with the same meaning as “located on” or “disposed on” and is not meant to be limiting regarding any particular fabrication process.

Hereinafter, a membrane electrode assembly including a proton conducting electrolyte membrane, a proton conducting ceramic fuel cells, and method of manufacturing the same according to one or more embodiments of the present invention will be described more fully with reference to the accompanying drawings.

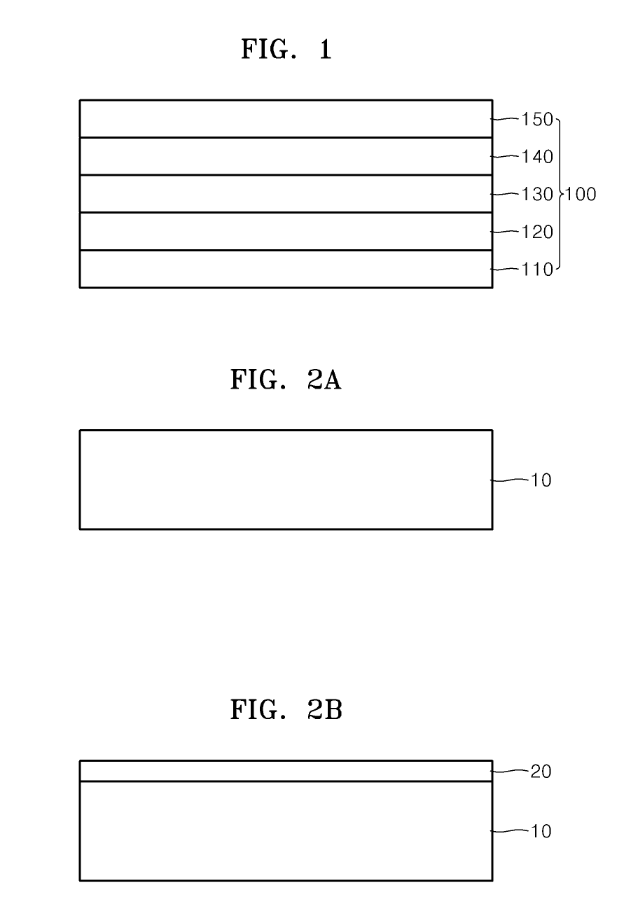

FIG. 1 is a cross-sectional view of a membrane electrode assembly 100 including a proton conducting electrolyte membrane, according to an embodiment of the present invention. Referring to FIG. 1, the membrane electrode assembly 100 according to the current embodiment includes an anode 110, an anode side ceramic protective layer 120, ceramic electrolyte layer 130, a cathode side ceramic protective layer 140, and a cathode 150. However, the membrane electrode assembly 100 according to other embodiments of the present invention may only include the anode side ceramic protective layer 120 or the cathode side ceramic protective layer 140.

The anode 110 and the cathode 150 may each be, independently, a porous thin layer or non-porous thin layer. That is, the anode 110 and the cathode 150 may each be a porous thin layer. The size of pores in a porous anode thin layer or a porous cathode thin layer may be in the range of about 5 to about 500 nm. However, the present invention is not limited thereto and the size of pores may be appropriately adjusted.

The anode 110 and the cathode 150 may each be an oxygen ion or hydrogen ion permeable thin layer. The anode 110 and the cathode 150 may each independently include at least one metal selected from the group consisting of: platinum (Pt); nickel (Ni); palladium (Pd); silver (Ag); perovskite doped with at least one metal selected from the group consisting of lanthanum (La), strontium (Sr), barium (Ba), and cobalt (Co); yttrium (Y) or scandium (Sc)-doped zirconia; ceria (Ce) doped with at least one selected from the group consisting of gadolinium (Gd), samarium (Sm), lanthanum (La), ytterbium (Yb), and neodymium (Nd); at least one proton conducting metal selected from the group consisting of Pd, a Pd—Ag alloy, RuO₂, H×WO₃ (0<x≦1), and V; zeolite; a lanthanum (La) or calcium (Ca)-doped strontium manganese oxide (LSM); and a lanthanum strontium cobalt iron oxide (LSCF). However, the materials for formation of the anode 110 and the cathode 150 are not limited thereto and any material which may be used to form an anode or a cathode in the art to which the present invention pertains may be used as forming materials of the anode 110 and the cathode 150.

The anode 110 and the cathode 150 may each independently have a thickness of about 1 μm or below. For example, the anode 110 and the cathode 150 may each independently have a thickness in the range of about 5 nm to about 1 μm or in the range of about 5 to about 500 nm, for example, a thickness in the range of about 5 to about 200 nm.

At least any one of the anode 110 and the cathode 150 may further include a catalyst. For example, a catalyst may be further disposed on the surfaces of the anode 110 and the cathode 150. For example, a porous catalyst layer including a catalyst may be disposed on the outsides of the anode 110 and the cathode 150. The catalyst may include submicron particles, for example, nanoparticles.

The catalyst may include one or more metals or alloys selected from the group consisting of platinum (Pt), gold (Au), silver (Ag), ruthenium (Ru), nickel (Ni), palladium (Pd), cobalt (Co), titanium (Ti), and vanadium (V). Also, the catalyst may include at least one oxide catalyst selected from the group consisting of La₁₋ₓSrₓMnO₃ (0<x<1), La₁₋ₓSrₓCoO₃ (0<x<1), and La₁₋ₓSrₓCO_{y}Fe_{1-y}O₃ (0<x<1, 0<y<1). For example, the catalyst may include at least one metal or alloy selected from the group consisting of Pt, Pt—Ru, Pt—Co, Pt—Fe, Pt—Ni, Pt—Ti, and Pt—V. As the catalyst is further included, the rate of hydrogen ionization may increase.

The ceramic electrolyte layer 130, which is interposed between the anode side ceramic protective layer 120 and the cathode side ceramic protective layer 140, is a layer through which protons are transmitted between the anode 110 and the cathode 150 and prevents oxygen from contacting hydrogen. The ceramic electrolyte layer 130 may transmit oxygen ions in addition to protons. For example, the ceramic electrolyte layer 130 may include at least one doped perovskite selected from a parent perovskite group including barium zirconate (BZ), barium cerate (BC), strontium cerate (SC), strontium zirconate (SZ), and solid solutions thereof. However, the present invention is not limited thereto and at least one of the parent perovskite group may be doped with at least one of a divalent cation of calcium (Ca) and ytterbium (Yb), etc. and a trivalent cation of yttrium (Y) and scandium (Sc), etc.

The thickness of the ceramic electrolyte layer 130 may be 2 μm or below. For example, the ceramic electrolyte layer 130 may have a thickness of about 5 nm to about 2 μm, or for example, about 5 nm to about 500 nm, or more specifically, about 5 nm to about 200 nm.

The anode side ceramic protective layer 120 and the cathode side ceramic protective layer 140 are disposed on the anode 110 and the cathode 150, respectively, and prevent gases such as carbon dioxide and sulfur oxides which flow through the anode 110 and the cathode 150 from penetrating into the ceramic electrolyte layer 130. The gases such as carbon dioxide and sulfur oxides may be included in fuel or generated in the anode 110 and the cathode 150. Accordingly, the anode side ceramic protective layer 120 and the cathode side ceramic protective layer 140 may prevent the electrolyte of the ceramic electrolyte layer 130 from reacting with gases existing in the anode 110 and the cathode 150 and therefore deteriorating.

A material, which may be used as a ceramic protective layer 120 or 140 of the ceramic electrolyte layer 130 including an inorganic proton conductor such as BYZ or BYC that mainly transmit protons, may have the proton conductivity as well as chemical stability explained above. If the ceramic protective layer 120 or 140 cannot transmit protons, the protons cannot pass the respective ceramic protective layer and thus a fuel cell may not be constructed.

Thicknesses of the ceramic protective layers 120 or 140 may be less than or equal to 100 nm. That is, thicknesses of the anode side ceramic protective layer 120 and the cathode side ceramic protective layer 140 may each be less than or equal to 100 nm. For example, the anode side ceramic protective layer 120 and the cathode side ceramic protective layer 140 may each have a thickness of about 1 nm to about 100 nm. For example, the ceramic electrolyte layer 130 may have a thickness of about 10 nm to about 100 nm, more specifically, about 15 nm to about 50 nm.

Yttrium-stabilized zirconia (YSZ) is an electrolyte that is widely used in a solid oxide fuel cell (SOFC) and is generally known as an oxygen ion (O²⁻) conductor. Accordingly, YSZ may not be used as the ceramic protective layer 120 or 140 of the ceramic electrolyte layer 130 including an inorganic proton conductor such as BYZ or BYC that mainly transmit protons.

However, nano-grain YSZ having an average crystal grain size of about 100 nm or below, as the anode side ceramic protective layer 120 and the cathode side ceramic protective layer 140, does not have a significant proton conductivity at a high temperature of about 550 to about 700° C.; however nano-grain YSZ has a significant proton conductivity, in addition to oxygen ion conductivity, at room temperature to a temperature of about 500° C. Thus, the nano-grain YSZ may be used as the ceramic protective layer 120 or 140 of the ceramic electrolyte layer 130 including the inorganic proton conductor such as BYZ or BYC. Accordingly, in the membrane electrode assembly 100 according to this embodiment of the present invention, the anode side ceramic protective layer 120 and the cathode side ceramic protective layer 140 include polycrystalline YSZ in an amorphous YSZ matrix, wherein the crystal grain of the polycrystalline YSZ is a nano-grain YSZ having an average crystal grain size of about 100 nm or below. The average crystal grain size of the nano-grain YSZ may be a few tens of nm, for example, greater than or equal to 5 nm and less than 100 nm. The average crystal grain size of the nano-grain YSZ may be determined as an average value of diameters of 10 grains randomly selected from a transmission electron microscopic (TEM) image. The average crystal grain size of the nano-grain YSZ may also be obtained from an X-ray diffraction diagram. Amorphous ZrP₂O₇ or amorphous Al:SiO₂ may be used as the anode side ceramic protective layer 120 and the cathode side ceramic protective layer 140, instead of the nano-grain YSZ.

The nano-grain YSZ has a significant proton conductivity, in addition to an oxygen ion conductivity, at room temperature to a temperature of about 500° C., for example, at about 200 to about 500° C. Thus, the nano-grain YSZ may be used as a ceramic protective layer of a ceramic electrolyte fuel cell, which operates at a temperature of about 200 to about 500° C. and depends on proton conductivity. Grain boundaries of the nano-grain YSZ may be paths through which protons are transmitted. Proton conductivity of the nano-grain YSZ may be acceptable when a deuterium (²H) concentration measured by using secondary ion mass spectroscopy (SIMS) is 0.05×10¹⁹/cm³ or above after nano-grain YSZ sample is exposed for 2 hours at 450° C. under a D₂O(²H₂O) atmosphere of 15 mTorr.

The proton conducting ceramic fuel cell according to this embodiment of the present invention may use at least one fuel selected from the group consisting of hydrogen, methane, natural gas, methanol, ethanol, dimethyl ether, and liquified hydrocarbon gas.

The membrane electrode assembly 100 including the proton conducting electrolyte membrane and the proton conducting ceramic fuel cell may have the following advantages:

(1) A ceramic protective layer 120 or 140 may have an improved chemical bond with the ceramic electrolyte layer 130, compared with a Pd metal protective layer, such that interlayer delamination may be lessened. Also, an electric short that can otherwise be prevented between the anode 110 and the cathode 150 due to diffusion of a metal to the ceramic electrolyte layer 130 may be prevented. In particular, compared with the Pd metal protective layer, the nano-grain YSZ ceramic protective layer is more appropriate for ceramic electrolytes such as BYZ and BYC that transmit protons or simultaneously transmit protons and oxygen ions used in a fuel cell operating at a temperature of about 200 to about 500° C., for example, about 250 to about 500° C.

(2) When an oxide-based electrode is used, the nano-grain YSZ ceramic protective layer may have improved bonding capability, compared with a metal-based chemical protective layer. Accordingly, compatibility between the electrode and the protective layer is improved.

(3) The ceramic protective layer 120 or 140 such as the nano-grain YSZ ceramic protective layer has oxygen ion conductivity, in addition to proton conductivity. Accordingly, unlike a metal-based protective layer, the nano-grain YSZ ceramic protective layer may be applied to a ceramic electrolyte layer that transmits both oxygen ion and proton. Thus, oxygen ion conductivity that may appear secondarily in a proton conductor may also be used, thereby improving performance of the fuel cell.

(4) The nano-grain YSZ ceramic protective layer has proton conductivity even in a low vapor pressure condition and thus may be applied to forming a fuel cell that does not need water management.

(5) The ceramic protective layer 120 or 140 is economically reasonable, compared with a Pd, RuOx, or Pd alloy protective layer including noble metals.

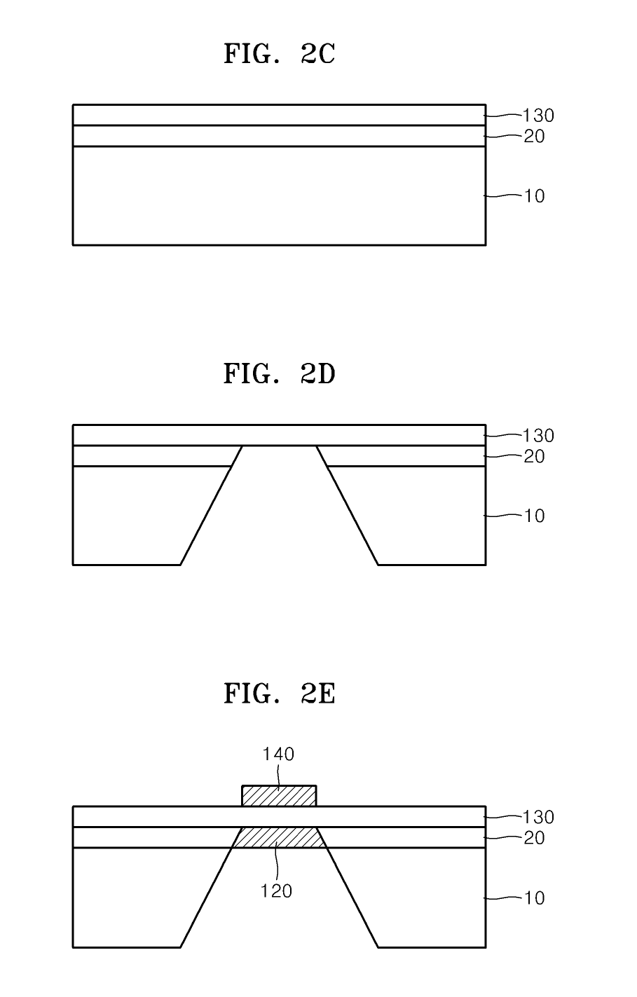

FIGS. 2A through 2F are cross-sectional views illustrating a method of manufacturing a membrane electrode assembly including a proton conducting electrolyte membrane, according to another embodiment of the present invention.

Referring to FIG. 2A, a substrate 10 is prepared. The substrate 10 may be a silicon substrate, a manganese oxide substrate, or an alumina substrate.

Referring to FIG. 2B, an etch-stop layer 20 is formed on a front side of the substrate 10. The etch-stop layer 20 may prevent the ceramic electrolyte layer 130 including an inorganic proton conductor from being damaged during etching of the substrate 100. The etch-stop layer 20 may include a silicon nitride layer, a silicon oxide layer, or a metal layer. For example, the etch-stop layer 20 may include SiO₂; Si₃N₄; or a metal or alloy including Cr, Au, Pd, Pd—Ag, V, or Pt.

Referring to FIG. 2C, the ceramic electrolyte layer 130 including an inorganic proton conductor that transmits protons or simultaneously transmits protons and oxygen ions is formed on the front side of the substrate 10. The inorganic proton conductor may include at least one doped perovskite selected from a parent perovskite group including barium zirconate (BZ) doped with at least one of a divalent cation and a trivalent cation, barium cerate (BC) doped with at least one of a divalent cation and a trivalent cation, strontium cerate (SC) doped with at least one of a divalent cation and a trivalent cation, strontium zirconate (SZ) doped with at least one of a divalent cation and a trivalent cation, and solid solutions thereof.

Referring to FIG. 2D, a predetermined area of the back side of the substrate 10 is removed so as to expose the back side of the ceramic electrolyte layer 130. When the predetermined area of the back side of the substrate 10 is removed, the substrate 10 is first removed by using wet etching and the etch-stop layer 20 is then removed by using dry etching. Accordingly, the back side of the ceramic electrolyte layer 130 may be exposed. When the substrate 10 is formed of silicon, the substrate 10 may be removed by using wet etching, in which, for example, a KOH solution is used. Then, when the etch-stop layer 20 is a silicon nitride layer, the etch-stop layer 20 may be completely etched by using dry etching, in which O₂ and SF₆ are used, wherein SF₆ is adsorbed to on the silicon surface and is dissociated to sulfur (S) and fluorine (F). Fluorine (F) is the main etchant in a silicon etching process. Such a silicon etching process may be represented by the following reaction formula: 2SF₆+3Si→2S+3SiF₄. SF₆ has a relatively high etching speed and does not need ion bombardment or an external energy source for etching silicon.

Referring to FIG. 2E, the anode side ceramic protective layer 120 and the cathode side ceramic protective layer 140 are formed on the exposed back side of the ceramic electrolyte layer 130 and the ceramic electrolyte layer 130 that is opposite to the back side of the ceramic electrolyte layer 130, respectively. These ceramic protective layers 120 and 140 prevent penetration of carbon dioxide, and optionally, sulfur oxides (SO_{X}) as well so as to protect the ceramic electrolyte layer 130. However, only one of the anode side ceramic protective layer 120 and the cathode side ceramic protective layer 140 may need to be formed according to the requirements for the specific fuel cell. These ceramic protective layers 120 or 140 include polycrystalline YSZ in an amorphous YSZ matrix, wherein the grain of the polycrystalline YSZ is a nano-grain YSZ having an average crystal grain size of about 100 nm or below. The average crystal grain size of the nano-grain YSZ may be in the range of greater than or equal to 5 nm and less than 100 nm. The nano-grain YSZ has significant proton conductivity at a temperature of about 200 to about 500° C.

Such nano-grain YSZ ceramic protective layers 120 and 140 may be formed by using atomic layer deposition (ALD), chemical vapor deposition (CVD), pulsed laser deposition (PLD), sputtering, or spray pyrolysis. Proton conductivity of the nano-grain YSZ chemical protective layers may be acceptable when a deuterium (²H) concentration measured by using SIMS is 0.05×10¹⁹/cm³ or above after the nano-grain YSZ sample is exposed for about 2 hours at 450° C. under a D₂O(²H₂O) atmosphere of 15 mTorr.

Referring to FIG. 2F, the anode 110 and the cathode 150 are formed on the anode side ceramic protective layer 120 and the cathode side ceramic protective layer 140, respectively. The anode 110 and the cathode 150 may each independently include at least one doped perovskite selected from the group consisting of: platinum (Pt); nickel (Ni); palladium (Pd); silver (Ag); perovskite doped with at least one metal selected from the group consisting of lanthanum (La), strontium (Sr), barium (Ba), and cobalt (Co); yttrium (Y) or scandium (Sc)-doped zirconia; ceria (Ce) doped with at least one rare earth selected from the group consisting of gadolinium (Gd), samarium (Sm), lanthanum (La), ytterbium (Yb), and neodymium (Nd); at least one proton conducting metal selected from the group consisting of Pd, a Pd—Ag alloy, RuO₂, H×WO₃ (0<x≦1), and V; zeolite; a lanthanum (La) or calcium (Ca)-doped strontium manganese oxide (LSM); and a lanthanum strontium cobalt iron oxide (LSCF).

The anode 110 and the cathode 150 may be formed by using sputtering, CVD, physical vapor deposition (PVD), ALD, plating, PLD, molecular-beam epitaxy, or vacuum deposition. However, the present invention is not limited thereto and the anode 110 and the cathode 150 may be formed by using any thin film forming method used in the art to which the present invention pertains. The plating includes both electrolytic plating and non-electrolytic plating.

A catalyst (not illustrated) may be further formed on at least one of the anode 110 and the cathode 150. The catalyst may be in nano-particle form. The catalyst may be formed by using sputtering, CVD, PVD, ALD, plating, PLD, molecular-beam epitaxy, or vacuum deposition. However, the present invention is not limited thereto and the catalyst may be formed by using any thin film forming method used in the art to which the present invention pertains. The plating includes both electrolytic plating and non-electrolytic plating. The catalyst may include one or more metals or alloys selected from the group consisting of platinum (Pt), gold (Au), silver (Ag), ruthenium (Ru), nickel (Ni), palladium (Pd), cobalt (Co), titanium (Ti), and vanadium (V). Also, the catalyst may include at least one oxide catalyst selected from the group consisting of La₁₋ₓSrₓMnO₃ (0<x<1), La₁₋ₓSrₓCoO₃ (0<x<1), and La₁₋ₓSrₓCO_{y}Fe_{1-y}O₃ (0<x<1, 0<y<1). For example, the catalyst may include at least one metal or alloy selected from the group consisting of Pt, Pt—Ru, Pt—Co, Pt—Fe, Pt—Ni, Pt—Ti, and Pt—V.

In embodiments of the present invention, a method of manufacturing a membrane electrode assembly including a proton conducting electrolyte membrane and a proton conducting ceramic fuel cell is not limited to the method illustrated in FIGS. 2A through 2F. For example, the membrane electrode assembly including a proton conducting electrolyte membrane and the proton conducting ceramic fuel cell may be formed by sequentially stacking the anode 110, the anode side ceramic protective layer 120, the ceramic electrolyte layer 130, the cathode side ceramic protective layer 140, and the cathode 150 on a support (not illustrated).

The disclosed embodiments will be described in further detail with reference to the following examples. The following examples are for illustrative purposes only and are not intended to limit the scope of the invention.

### EXAMPLES

### Preparation Examples 1 Through 3

In order to verify proton conductivity of nano-grain YSZ (8 mol % Y₂O₃-stabilized ZrO₂), the change in deuterium concentration according to thicknesses of YSZ layers was analyzed, wherein the YSZ layers include nano-grain YSZ thin layers (thickness: about 100 nm) each having an average crystal grain size of about 25 nm that are deposited by using ALD (Preparation Example 1) and PLD (Preparation Example 2), and a micro-grain YSZ thin layer (thickness: about 500 μm) having an average crystal grain size of about 10 μm formed by using sintering (Preparation Example 3) on a Si₃N₄ layer having a thickness of about 100 nm formed on a Si wafer having a thickness of about 350 μm.

The nano-grain YSZ thin layer according to Preparation Example 1 was deposited by carrying out the following processes in a reaction chamber:

(1) A Si₃N₄ substrate maintained at 250° C. was exposed to tetrakis(dimethylamido)zirconium (heating temperature of 75° C.) gas in a reaction chamber,

(2) The reaction chamber was purged by using Ar gas,

(3) The Si₃N₄ substrate maintained at 250° C. was exposed to H₂O gas,

(4) The reaction chamber was purged by using Ar gas,

(5) The Si₃N₄ substrate maintained at 250° C. was exposed to tris(methylcyclopentadienyl)yttrium gas (pyrolysis temperature of 190° C.),

(6) The reaction chamber was purged by using Ar gas,

(7) The Si₃N₄ substrate maintained at 250° C. was exposed to H₂O gas, and

(8) The reaction chamber was purged by using Ar gas.

The nano-grain YSZ thin layer according to Preparation Example 2 was deposited as follows:

In a reaction chamber, in which the inside of the chamber was evacuated and then oxygen partial pressure was adjusted to about 100 mTorr, a KrF laser having pulse energy of 3.0 J/cm2 was beamed at a BYZ target so as to form a BYZ plasma. Then, the nano-grain YSZ thin layer was deposited on the Si₃N₄ substrate that was spaced apart from the target by 6.5 cm and was maintained at 400° C.

The nano-grain YSZ thin layer according to Preparation Example 3 was deposited as follows:

YSZ powder was sintered at about 1650° C. so as to form the nano-grain YSZ thin layer.

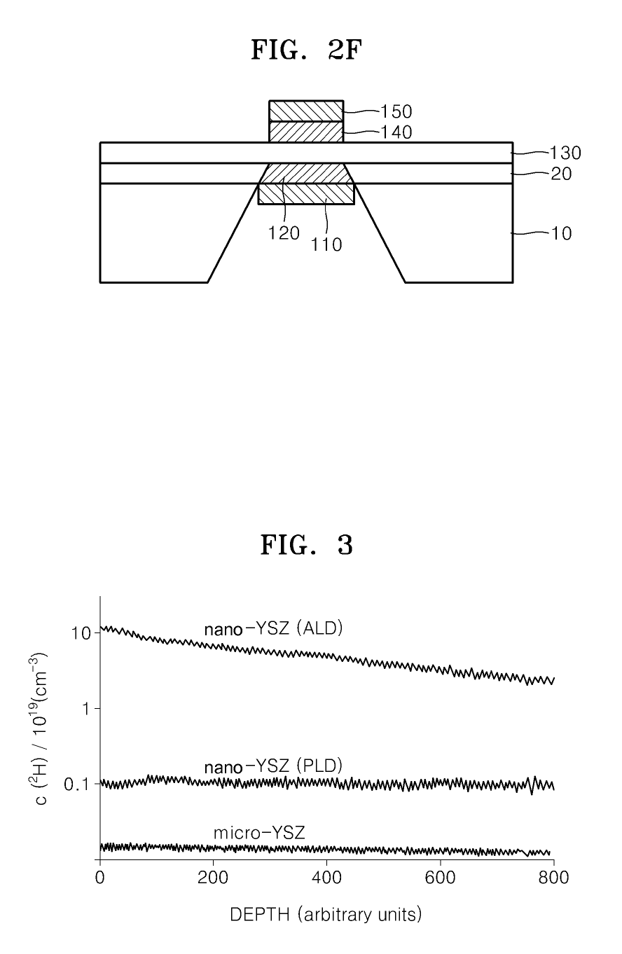

FIG. 3 is a graph showing the changes in deuterium concentration according to thicknesses of YSZ layers in Preparation Example 1 (nano-YSZ (ALD)), Preparation Example 2 (nano-YSZ (PLD)), and Preparation Example 3 (micro-YSZ) measured by using SIMS.

Here, YSZ thin layer samples were annealed for about 2 hours at 450° C. under a D₂O(²H₂O) partial pressure (P_{D2O}) atmosphere of 15 mTorr and then the change in deuterium (D=²H) concentration was measured at a predetermined depth from the surfaces of the thin YSZ layers by using SIMS. The YSZ thin layers may be used as a ceramic protective layer 120 or 140 when proton conductivity thereof measured in such a condition is greater or equal to 0.05×10¹⁹/cm³ throughout the thicknesses of the thin layers. Referring to FIG. 3, deuterium concentrations were high throughout the entire thicknesses of each thin layer in Preparation Example 1 (nano-YSZ (ALD)) and Preparation Example 2 (nano-YSZ (PLD)), whereas the deuterium concentration was hardly detected throughout the entire thicknesses of the thin layer in Preparation Example 3 (micro-YSZ). In particular, the nano-YSZ formed by using ALD according to Preparation Example 1 indicated a high deuterium concentration of 10²⁰/cm³ at the surface. However, in the micro-YSZ according to Preparation Example 3, the deuterium concentration was below the limit of detection. In the nano-YSZ formed by using PLD according to Preparation Example 2, the deuterium concentration was lower than that formed by using ALD. However, such a deuterium concentration was still significantly higher than a reference value of 0.05×10¹⁹/cm³ and that of the micro-YSZ in Preparation Example 3 and was similar at the inside of the layer. Accordingly, since the nano-grain YSZ thin layer transmits hydrogen ions (protons) well at a temperature of about 200 to about 500° C., the nano-grain YSZ thin layer may be used as a ceramic protective layer 120 or 140 of a ceramic electrolyte layer 130 including an inorganic proton conductor.

### Example 1

A silicon nitride layer having a thickness of about 100 nm, as an etch-stop layer, was deposited on a silicon substrate heated to about 800° C. by using low pressure chemical vapor deposition (LPCVD) (FIGS. 2A and 2B).

A proton conducting solid oxide electrolyte thin layer (BYZ; Y:BaZrO₃) was deposited to a thickness of about 100 nm on the silicon nitride layer (FIG. 2C).

A predetermined area of the back side of the silicon substrate was exposed by using photolithography and then the silicon substrate was impregnated with 30 weight % of a KOH solution for about 4 hours, thereby first removing the silicon substrate. Then, the exposed silicon nitride layer was removed by using drying etching, in which SF₆ and O₂ were used, in a reaction chamber, thereby exposing the back side of the BYZ ceramic electrolyte layer (FIG. 2D).

ALD, in which the following processes were repeated, was performed on the obtained silicon substrate in a reaction chamber and thus the nano-grain YSZ thin layer was deposited (FIG. 2E): (1) the silicon substrate maintained at 250° C. was exposed to tetrakis(dimethylamido) zirconium gas, (2) the reaction chamber was purged by using Ar gas, (3) the silicon substrate maintained at 250° C. was exposed to H₂O gas, (4) the reaction chamber was purged by using Ar gas, (5) the silicon substrate maintained at 250° C. was exposed to tris(methylcyclopentadienyl) yttrium gas (pyrolysis temperature of 190° C.), (6) the reaction chamber was purged by using Ar gas, and (7) the silicon substrate maintained at 250° C. was exposed to H₂O gas.

The anode side ceramic protective layer 120 and the cathode side ceramic protective layer 140 each including the nano-grain YSZ having an average crystal grain size of about 25 nm and a thickness of about 5 nm were respectively formed on the back side of the exposed ceramic electrolyte layer 130 and the front side of the ceramic electrolyte layer 130, that is opposite to the back side of the ceramic electrolyte layer 130.

Finally, a mask was placed on each of the anode side ceramic protective layer 120 and the cathode side ceramic protective layer 140 and a porous Pt thin layer having a thickness of about 80 nm was formed on each of the anode side ceramic protective layer 120 and the cathode side ceramic protective layer 140 by using sputtering. Thus, the porous Pt anode 110 and the porous Pt cathode 150 were formed, thereby manufacturing a membrane electrode assembly (MEA) (FIG. 2F).

### Example 2

A MEA was manufactured as in Example 1, except that the anode side ceramic protective layer 120 and the cathode side ceramic protective layer 140 each including a nano-grain YSZ having an average crystal grain size of about 25 nm and a thickness of about 5 nm were formed by using PLD, instead of using ALD:

In a reaction chamber, in which the inside of the chamber was evacuated and then the oxygen partial pressure was adjusted to about 100 mTorr, KrF laser having pulse energy of 3.0 J/cm² was beamed toward a YSZ target so as to form a YSZ plasma. Then, the nano-grain YSZ thin layer was deposited on a silicon substrate that was spaced apart from the target by 6.5 cm and was maintained at 400° C.

### Comparative Example 1

A MEA was manufactured as in Example 1, except that the anode side ceramic protective layer 120 and the cathode side ceramic protective layer 140 each including a micro-grain YSZ having an average crystal grain size of about 10 μm and a thickness of about 500 μm were formed by sintering YSZ powders at 1650° C., instead of using ALD.

In the MEAs of Examples 1 and 2, open circuit voltages (OCV) were identified. However, OCV was not identified in the MEA of Comparative Example 1. Accordingly, in a proton conducting ceramic electrolyte fuel cell, the nano-grain YSZ thin layer may be used as a ceramic protective layer 120 or 140, whereas the micro-grain YSZ thin layer may not be used as a protective layer.

### Example 3

On a Si chip having a size of 1 cm×1 cm, a BYZ thin layer as a solid oxide electrolyte was deposited to a thickness of about 200 nm on a freestanding silicon nitride thin layer having a size of 50 μm×50 μm (thickness: about 100 nm), The solid oxide electrolyte thin layer was deposited by PLD using BaZr_{0.8}Y_{0.2}O₃₋ as a target material under the conditions of temperature of 600° C., oxygen pressure of 30 mTorr, laser output of 200 mJ, laser frequency of 5 Hz, deposition time of 27 minutes (about 8100 pulses), and a target-substrate distance of 75 mm.

The silicon nitride thin layer was removed by using plasma etching so as to form a freestanding BYZ thin layer. The plasma etching was performed under the following conditions:

Etching gas and flow rate: O₂: 10 sccm, SF₆: 100 sccm,

Chamber pressure: 150 mTorr

RF power: 83 W

Etching time: about 2 min

A nano-grain YSZ thin layer (thickness: about 25 nm) having an average crystal grain size of about 25 nm was deposited as an anode side ceramic protective layer on the anode side surface of the BYZ electrolyte thin layer by using the ALD method described in Example 1.

A nano-grain YSZ thin layer (thickness: about 25 nm) having an average crystal grain size of about 25 nm was deposited again as a cathode side ceramic protective layer on the cathode side surface of the BYZ electrolyte thin layer by using the ALD method described in Example 1.

A porous Pt thin layer was deposited to a thickness of about 80 nm as an anode on the anode side ceramic protective layer. The anode was deposited by sputtering using highly pure Pt as a target material under the conditions of output of 200 W, a target-substrate distance of 80 mm, an argon atmosphere of pressure of 5 mTorr, and deposition time of 7 minutes.

A porous Pt thin layer was deposited to a thickness of about 80 nm as a cathode on the cathode side ceramic protective layer. The cathode was deposited by sputtering using highly pure Pt as a target material under the conditions of output of 200 W, a target-substrate distance of 80 mm, an argon atmosphere of pressure of 5 mTorr, and deposition time of 7 minutes. Therefore, a membrane electrode assembly was manufactured.

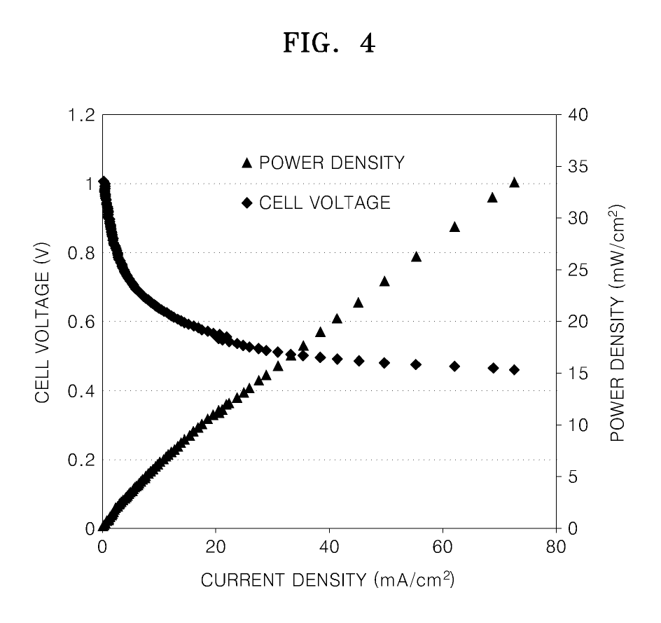

FIG. 4 is a graph showing cell performance evaluation for a membrane electrode assembly manufactured according to Example 3 at a mid-temperature range of about 350° C. Referring to FIG. 4, the membrane electrode assembly shows a maximum output density of 35 mW/cm². Thus, it has been demonstrated that a fuel cell based on proton conductivity including the nano-grain YSZ thin layer as the ceramic protective layer functions normally.

As described above, according to one or more of the above embodiments of the present invention, the membrane electrode assembly including a proton conducting electrolyte membrane and proton conducting ceramic fuel cell may have following advantages:

(1) A ceramic protective layer may have an improved chemical bond with a ceramic electrolyte layer, compared with a Pd metal protective layer, such that interlayer delamination may be lessened. Also, an electric short occurring between the anode and the cathode due to diffusion of a metal to the ceramic electrolyte layer may be prevented. In particular, compared with the Pd metal protective layer, the nano-grain YSZ ceramic protective layer is more appropriate for ceramic electrolytes such as BYZ and BYC that transmit protons or simultaneously transmit protons and oxygen ions used in a fuel cell operating at a temperature of about 200 to about 500° C., for example, about 250 to about 500° C.

(2) When an oxide-based electrode is used, the nano-grain YSZ ceramic protective layer may have improved bonding capability, compared with a metal-based chemical protective layer. Accordingly, compatibility between the electrode and the protective layer is improved.

(3) The ceramic protective layer such as the nano-grain YSZ ceramic protective layer has oxygen ion conductivity, in addition to proton conductivity. Accordingly, unlike a metal-based protective layer, the nano-grain YSZ ceramic protective layer may be applied to a ceramic electrolyte layer that transmits both oxygen ions and protons. Thus, oxygen ion conductivity that may appear secondarily in a proton conductor may also be used, thereby improving performance of the fuel cell.

(4) The nano-grain YSZ protective layer has proton conductivity even in a low vapor pressure condition and thus may be applied to forming a membrane electrode assembly and a fuel cell which do not need water management.

(5) The ceramic protective layer is economically reasonable, compared with a Pd, RuOx, or Pd alloy protective layer including noble metals.

It should be understood that the exemplary embodiments described therein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton conducting electrolyte membrane comprising:
a ceramic electrolyte layer with an inorganic proton conductor; and
a ceramic protective layer formed on one surface or both surfaces of the ceramic electrolyte layer and having proton conductivity.

2. The proton conducting electrolyte membrane of claim 1, wherein the ceramic protective layer comprises polycrystalline yttrium-stabilized zirconia (YSZ) in an amorphous YSZ matrix in which the crystal grain of the polycrystalline YSZ is nano-grain YSZ having an average crystal grain size of about 100 nm or below; M¹ₓM²₁₋ₓP₂O₇ (0<x<0.5) in which M¹ is a tetravalent metal cation, and M² is a monovalent to trivalent metal cation; MₓLa₁₋ₓPO₄ (0<x<0.5) in which Mₓ is Sr or Ca; CsH₂PO₄, or NH₄PO₃; at least one cathodic material selected from lanthanum strontium cobalt ferrite (LSCF), lanthanum strontium manganite (LSM), lanthanum strontium ferrite (LSF), lanthanum calcium manganite (LCM), lanthanum strontium chromite (LSC), lanthanum strontium gallate manganite (LSGM), barium strontium calcium ferrite (BSCF), and strontium-doped samarium cobaltite (SSC); Ba₂In₂O₇ doped with at least one cation; at least one doped perovskite selected from a parent perovskite group consisting of BT (barium titanate) doped with at least one of a divalent cation and a trivalent cation, ST (strontium titanate) doped with at least one of a divalent cation and a trivalent cation, and SZ (strontium zirconate) doped with at least one of a divalent cation and a trivalent cation; an amorphous ZrP₂O₇; or an amorphous Al:SiO₂.

3. The proton conducting electrolyte membrane of claim 2, wherein the average crystal grain size of the nano-grain YSZ is greater than or equal to about 5 nm and less than about 100 nm.

4. The proton conducting electrolyte membrane of claim 2, wherein the nano-grain YSZ has proton conductivity at a temperature range of about 200 to about 500° C.

5. The proton conducting electrolyte membrane of claim 2, wherein the deuterium (²H) concentration of the nano-grain YSZ measured after the nano-grain YSZ is exposed for two hours at 450° C. under a D₂O(²H₂O) atmosphere of 15 mTorr is greater or equal to 0.05×10¹⁹/cm³.

6. The proton conducting electrolyte membrane of claim 1, wherein the inorganic proton conductor comprises at least one doped perovskite selected from the parent perovskite group consisting of barium zirconate (BZ) doped with at least one of a divalent cation and a trivalent cation, barium cerate (BC) doped with at least one of a divalent cation and a trivalent cation, strontium cerate (SC) doped with at least one of a divalent cation and a trivalent cation, strontium zirconate (SZ) doped with at least one of a divalent cation and a trivalent cation, and solid solutions thereof.

7. The proton conducting electrolyte membrane of claim 1, wherein the ceramic protective layer prevents penetration of carbon dioxide.

8. The proton conducting electrolyte membrane of claim 1, wherein the ceramic electrolyte layer has a thickness of less than or equal to about 2 μm.

9. The proton conducting electrolyte membrane of claim 1, wherein the ceramic protective layer has a thickness of less than or equal to about 100 nm.

10. A membrane electrode assembly comprising:
an anode;
a cathode; and
a ceramic electrolyte membrane disposed between the anode and the cathode,
wherein the ceramic electrolyte membrane is a proton conducting electrolyte membrane comprising an inorganic proton conductor, and a ceramic protective layer is formed on one surface or both surfaces of the ceramic electrolyte layer and has proton conductivity.

11. The membrane electrode assembly of claim 10, wherein the ceramic protective layer includes polycrystalline yttrium-stabilized zirconia (YSZ) in an amorphous YSZ matrix in which the crystal grain of the polycrystalline YSZ is a nano-grain YSZ having an average crystal grain size of about 100 nm or below; M¹ₓM²₁₋ₓP₂O₇ (0<x<0.5) in which M¹ is a tetravalent metal cation, and M² is a monovalent to trivalent metal cation; MₓLa₁₋ₓPO₄ (0<x<0.5) in which Mₓ is Sr or Ca; CsH₂PO₄, or NH₄PO₃; at least one cathodic material selected from lanthanum strontium cobalt ferrite (LSCF), lanthanum strontium manganite (LSM), lanthanum strontium ferrite (LSF), lanthanum calcium manganite (LCM), lanthanum strontium chromite (LSC), lanthanum strontium gallate manganite (LSGM), barium strontium calcium ferrite (BSCF), and strontium-doped samarium cobaltite (SSC); Ba₂In₂O₇ doped with at least one cation; at least one doped perovskite selected from the parent perovskite group consisting of BT (barium titanate) doped with at least one of a divalent cation and a trivalent cation, ST (strontium titanate) doped with at least one of a divalent cation and a trivalent cation, and SZ (strontium zirconate) doped with at least one of a divalent cation and a trivalent cation; an amorphous ZrP₂O₇; or an amorphous Al:SiO₂.

12. The membrane electrode assembly of claim 11, wherein the average crystal grain size of the nano-grain YSZ is greater than or equal to about 5 nm and less than about 100 nm.

13. The membrane electrode assembly of claim 11, wherein the nano-grain YSZ has proton conductivity at a temperature range of about 200 to about 500° C.

14. The membrane electrode assembly of claim 11, wherein the deuterium (²H) concentration of the nano-grain YSZ measured after the nano-grain YSZ is exposed for two hours at 450° C. under a D₂O(²H₂O) atmosphere of 15 mTorr is greater or equal to 0.05×10¹⁹/cm³.

15. The membrane electrode assembly of claim 10, wherein the inorganic proton conductor comprises at least one doped perovskite selected from the parent perovskite group comprising barium zirconate (BZ) doped with at least one of a divalent cation and a trivalent cation, barium cerate (BC) doped with at least one of a divalent cation and a trivalent cation, strontium cerate (SC) doped with at least one of a divalent cation and a trivalent cation, strontium zirconate (SZ) doped with at least one of a divalent cation and a trivalent cation, and solid solutions thereof.

16. The membrane electrode assembly of claim 10, wherein the ceramic protective layer prevents penetration of carbon dioxide.

17. The membrane electrode assembly of claim 10, wherein the ceramic electrolyte layer has a thickness of less than or equal to about 2 μm.

18. The membrane electrode assembly of claim 10, wherein the ceramic protective layer has a thickness of less than or equal to about 100 nm.

19. A proton conducting ceramic fuel cell comprising the membrane electrode assembly of claim 10.

20. A proton conducting ceramic fuel cell comprising the membrane electrode assembly of claim 11.
